(19) United States
(12) Patent Application Publication
(10) Pub. No.: US 2006/0262757 A1
(43) Pub. Date: Nov. 23, 2006

(54) Reception apparatus and method for determining timer value for detecting missed frame in mobile communication system adopting radio link protocol

(75) Inventor: Yong-Soo Baek, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/406,964

(22) Filed: Apr. 19, 2006

(30) Foreign Application Priority Data
Apr. 25, 2005 (KR) 2005-33993

(51) Int. Cl. H04J 3/00

(52) U.S. Cl. 370/336; 370/394

(57) ABSTRACT

An optimal frame retransmission process is performed by more clearly recognizing a realtime communication environment and calculating a REXMIT_TIMER value suitable for the situation without using a fixed REXMIT_TIMER value. To do this, a state of a current communication environment is determined, an optimal REXMIT_TIMER value suitable for the state is calculated, and the optimal REXMIT_TIMER value is used as a reference to determine the status of a frame.

### PRIORITY

This application claims priority under 35 U.S.C. § 119 to an application entitled “Reception Apparatus and Method for Determining Timer Value for Detecting Missed Frame in Mobile Communication System Adopting RLP” filed in the Korean Intellectual Property Office on Apr. 25, 2005 and assigned Serial No. 2005-33993, the contents of which are incorporated herein by reference.

### BACKGROUND OF THE INVENTION

1. Field of the Invention

The present invention relates generally to a reception apparatus and method for determining a timer value for detecting a missed frame in a mobile communication system adopting a radio link protocol (RLP).

2. Description of the Related Art

In general, a code division multiple access (CDMA) mobile communication system has been developed from a voice-oriented IS-95 standard into a CDMA 2000 standard by which voice communication and high speed data communication are possible. According to the CDMA 2000 standard, services of high quality voice, audio/video (AV), and Internet surfing are possible.

Such a CDMA mobile communication system solves data loss occurring in a wireless environment using a radio link protocol (RLP) when data communication is performed. The RLP uses NAK based on an Automatic Repeat Request (ARQ) scheme in order to restore an error generated in an air channel. That is, if an RLP receiving end discovers an RLP frame which has not been received yet, the RLP receiving end transmits a NAK frame for requesting for retransmission of the corresponding RLP frame to an RLP transmitter, then the RLP transmitter which has received the request transmits the requested RLP frame to the RLP receiving end. The RLP is based on a frame having a length of 20 ms at a transmission rate of 9.6 Kbps, 14.4 Kbps, or below.

Types of frames used in RLP data communication can be roughly classified into a new frame and a retransmission frame, i.e., a new frame for transmitting new data and a retransmission frame for re-transmitting data in a sending side in response to a NAK frame received from a receiving side.

If a frame is not received, the receiving side transmits to the sending side a NAK frame including a non-received frame sequence as described above. Herein, a value used to estimate the occurrence of a missed frame in the receiving side is a REXMIT_TIMER. If a certain frame does not arrive while sequentially receiving frames, the receiving side dose not immediately request for the retransmission of the frame using a NAK frame but waits for the REXMIT_TIMER value. If the frame does not arrive yet, the receiving side estimates the frame as a missed frame, inserts a sequence of the missed frame into a NAK frame, and request the sending side for retransmission of the missed frame by transmitting the NAK frame.

The REXMIT_TIMER is a constant calculated from an RLP_DELAYs value. The RLP_DELAYs value is calculated by one of the following two methods. The RLP_DELAYs value is obtained from a round-trip-delay value in RLP sync exchange procedures, or a round-trip-time (RTT) value allocated by a base transceiver station (BTS) as a constant is used as the RLP_DELAYs value. The receiving side determines a missed frame based on the fixed RLP_DELAYs value, and thereby, a retransmission process is performed.

In an RLP layer of the receiving side, a REXMIT_TIMER value of a non-received RLP frame is decreased every time when a normal null, idle, or new frame is received, and if the REXMIT_TIMER value becomes 0, the frame is considered as a missed frame, and a retransmission process is performed for the frame.

When a subscriber station (SS) moves during data communication, or when a surrounding environment is changed, a communication environment and a communication state of the SS varies from time to time. However, the SS fixedly uses a REXMIT_TIMER value obtained from a constant (RLP_DELAYs) calculated in RLP sync exchange procedures, which is a portion of an initialization process, until a subsequent initialization process is performed. Otherwise, the SS uses an RTT value of an RLP BLOB (Block of Bits) frame obtained in RLP_BLOB, which is a portion of the initialization process, as the RLP_DELAYs value, and then the REXMIT_TIMER value is calculated from the RLP_DELAYs value. In the above two cases, the constant REXMIT_TIMER value is used for data communication until a new initialization process is performed.

### SUMMARY OF THE INVENTION

Due to the use of the constant REXMIT_TIMER, the SS cannot react to a changed surrounding environment, and therefore the SS is required to wait in a wait state or must request unnecessary and inappropriate retransmission in a further wait state.

This fully ignores a characteristic of a wireless communication environment influenced by an environment more than any other communication, and therefore the REXMIT_TIMER value should be changed to adapt to the environment.

Accordingly, the present invention provides a reception apparatus and method for determining in a real communication environment a timer value for detecting a missed frame in a mobile communication system adopting a radio link protocol (RLP).

According to one aspect of the present invention, there is provided a method for determining a timer value for detecting a missed frame in a reception apparatus of a mobile communication system adopting a radio link protocol (RLP), the method includes counting the number of frames whose retransmission is requested; and updating the timer value for detecting a missed frame by referring to the counting value.

According to another aspect of the present invention, there is provided a method for determining a timer value for detecting a missed frame in a reception apparatus of a mobile communication system adopting a radio link protocol (RLP), the method includes counting of each time section the number of frames whose retransmission is requested; and updating the timer value for detecting a missed frame by referring to the counting value of each time section.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram of a data communication system according to a preferred embodiment of the present invention;

FIG. 2 is a block diagram of a reception apparatus according to a preferred embodiment of the present invention;

FIG. 3 is a block diagram of an RLP processing part according to a preferred embodiment of the present invention;

FIG. 4 is a flowchart illustrating a process of receiving data in the RLP processing part according to a preferred embodiment of the present invention;

FIG. 5 is a flowchart illustrating a process of updating a REXMIT_TIMER value according to a first preferred embodiment of the present invention;

FIG. 6 is a flowchart illustrating a process of updating a REXMIT_TIMER value according to a second preferred embodiment of the present invention; and

FIG. 7 is a diagram illustrating REX_COUNT values of time sections.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

In the present invention, an optimal frame retransmission process is performed by recognizing a real communication environment and calculating a REXMIT_TIMER value suitable for individual situations without using a fixed REXMIT_TIMER value. To do this, in the present invention, a state of a current communication environment is determined, an optimal REXMIT_TIMER value suitable for the state is calculated, and the optimal REXMIT_TIMER value is used as a reference to determine a missed frame. In addition, the number of frames whose retransmission is requested to determine a current communication environment is counted. A process of counting the retransmission request frames can be included in a NAK list processing process or a NAK frame generating process. That is, in the present invention, the number of retransmission request frame sequences is counted, and the counting value (referred to herein as REX_COUNT) is used.

According to a preferred embodiment of the present invention, the REX_COUNT value is updated at every unit time when a frame is generated (20 ms unit in a case of a fundamental channel (FCH) and a supplemental channel (SCH)). Based on the range the REX_COUNT value is placed in, the REXMIT_TIMER value is updated by selecting one of ‘increment,’ ‘decrement,’ and ‘maintaining a current value.’According to another preferred embodiment of the present invention, the REX_COUNT value is checked at each time section. REX_COUNT values of time sections are compared to each other, and according to the comparison result, the REXMIT_TIMER value is updated by selecting one of ‘increment,’ ‘decrement,’ and ‘maintaining a current value.’

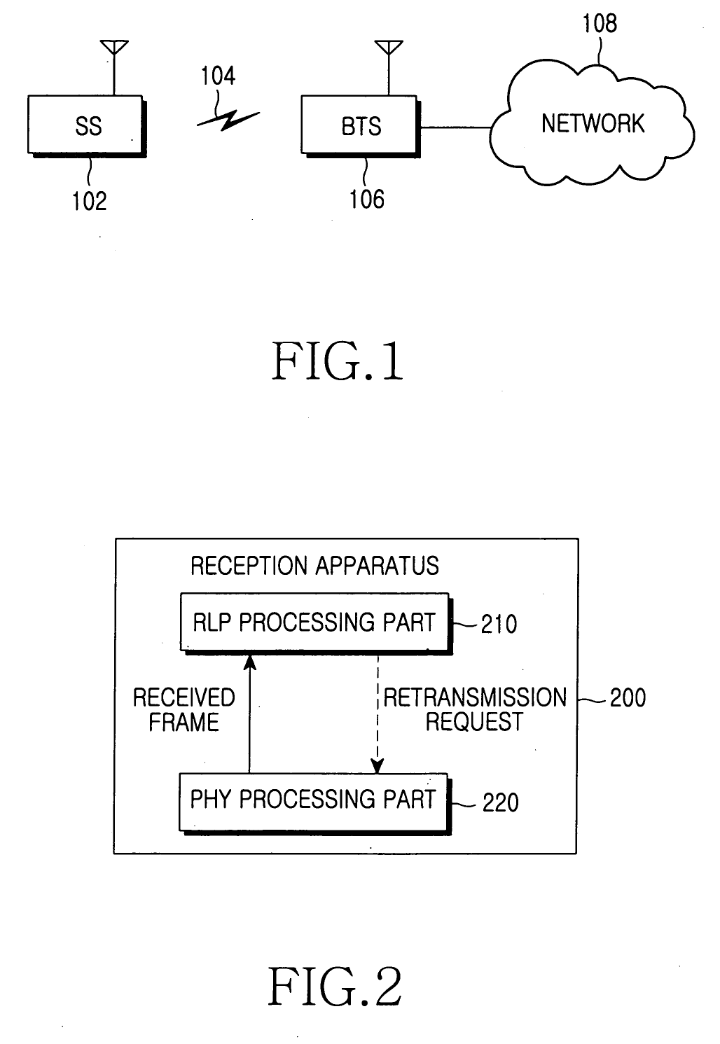

A data communication system configured according to a preferred embodiment of the present invention will now be described with reference to FIG. 1. Referring to FIG. 1, a subscriber station (SS) 102 communicates with a network 108 via a radio channel 104 and a base transceiver station (BTS) 106. The SS 102 and the BTS 106 establish a communication link to carry data byte streams on the radio channel 104. Data bytes exchanged between the SS 102 and the network 108 via the BTS 106 can be an Internet protocol (IP) datagram converted to a byte stream using a conversion protocol such as a point-to-point protocol (PPP). The IP and the PPP are well known to those in the art. Before certain data is exchanged between the SS 102 and the BTS 106, an RLP link between the SS 102 and the BTS 106 needs to be established. The RLP link establishment includes establishment of an RTT to be used by both the SS 102 and the BTS 106 for NAK timing. In general, a REXMIT_TIMER value is determined from the RTT value. As described above, the REXMIT_TIMER value is used to determine a missed frame when a reception apparatus receives frames transmitted from a transmitter.

In the prior art, a REXMIT_TIMER value obtained from an RTT value in such an initialization process is used until the RTT value is newly set in a subsequent initialization process. However, in the present invention, an optimal frame retransmission process is performed by more clearly recognizing a real communication environment and calculating a REXMIT_TIMER value suitable for the situation. According to a preferred embodiment of the present invention, if normal frames are more appropriately received in a current communication state than in a previous communication state, a reception apparatus reduces an unnecessary wait time by decreasing the REXMIT_TIMER value and quickly requests for retransmission. If an invalid frame, such as a missed frame or an erased frame, is frequently received, the reception apparatus determines that a current receive state is deteriorated and increases a frame waiting time by increasing the REXMIT_TIMER value.

By doing this, the reception apparatus can perform an optimal frame retransmission process by calculating a REXMIT_TIMER value suitable for a real communication environment without using a fixed_REXMIT_TIMER value. A hierarchical structure of a reception apparatus according to a preferred embodiment of the present invention will now be described.

FIG. 2 is a block diagram of a reception apparatus 200 according to a preferred embodiment of the present invention, showing only a configuration related to the present invention.

Referring to FIG. 2, the reception apparatus 200 includes a RLP processing part 210 and a physical layer (PHY) processing part 220. The PHY processing part 220 decodes a frame received when frame data is received and transmits the decoded frame to the RLP processing part 210. If the decoded frame is received, the RLP processing part 210 examines a sequence number of the received decoded frame. If the sequence number of the decoded frame received from the PHY processing part 220 is in the proper order of the received frames, the RLP processing part 210 transmits the frame to an upper layer. In detail, it is assumed that a transmitter sequentially transmits frame data in an order of sequence numbers 1, 2, 3, and 4. If the sequence numbers of the decoded frames received from the PHY processing part 220 are sequential, i.e. 1, 2, 3, and 4, the RLP processing part 210 transmits the frames to the upper layer. However, a frame of a certain number among the sequence numbers of the received frames may not be received. For example, if only frames of sequence numbers 2 and 4 are received, the RLP processing part 210 determines that the number of frames whose decoding has failed in the PHY processing part 220 is at least 2. That is, it can be known that errors are generated in frames of sequence numbers 1 and 3.

In this case, if the frame of the sequence number 2 is received in a state where the frame of the sequence number 1 has not been received, the RLP processing part 210 temporarily stores the frame of the sequence number 2 in a buffer and sets a timer (REXMIT_TIMER) for the non-received frame of the sequence number 1. Similarly, if the frame of the sequence number 4 is received in a state where the frame of the sequence number 3 has not been received, the RLP processing part 210 temporarily stores the frame of the sequence number 4 in the buffer and sets another timer (REXMIT_TIMER) for the non-received frame of the sequence number 3. Herein, different timers are set for every non-received frame. That is, the timers (REXMIT_TIMER) for the non-received frames are separate timers and operate independently in a time domain. However, the wait time values of the timers (REXMIT_TIMER) for the non-received frames are equal to each other, and thus waiting times of the non-received frames are also equal to each other. In the present embodiment, the timer values set to the non-received frames are dynamically set according to a current communication state.

To do this, the RLP processing part 210 outputs a REX_COUNT value obtained by counting the number of retransmission request frames. Herein, the REX_COUNT is a variable based on the number of retransmission request frame sequences. The RLP processing part 210 can perform a process of counting the number of retransmission request frames in a NAK list processing process or a NAK frame generating process.

According to a first preferred embodiment of the present invention, the RLP processing part 210 updates the REX_COUNT value at every unit time when a frame is generated (a 20 ms unit for an FCH and an SCH) and updates the REX_COUNT value by selecting one of ‘increment,’ ‘decrement,’ and ‘maintaining a current value.’

According to a second preferred embodiment of the present invention, the REX_COUNT value is checked at each time section, REX_COUNT values of time sections are compared to each other, and according to the comparison result, the REXMIT_TIMER value is updated by selecting one of ‘increment,’ ‘decrement,’ and ‘maintaining a current value.’

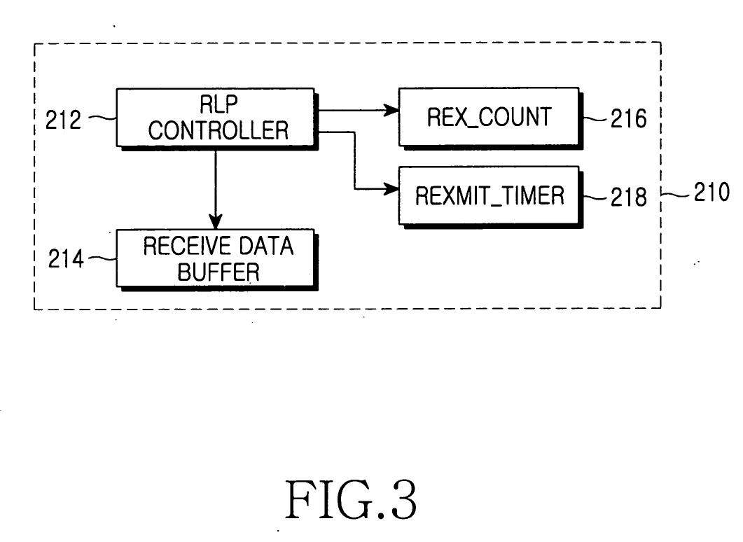

Thus the RLP processing part 210 can determine a missed frame based on an optimal REXMIT_TIMER value. The RLP processing part 210 stores a received frame in a buffer, in detail, a queue, and for example, if the frame of the sequence number 1 is received, the RLP processing part 210 transmits the frames of the sequence numbers 1 and 2 to the upper layer. If the frame of the sequence number 3 is received, the RLP processing part 210 transmits the frames of the sequence numbers 3 and 4 to the upper layer. The RLP processing part 210 can be configured as FIG. 3.

FIG. 3 is a block diagram of the RLP processing part 210 according to a preferred embodiment of the present invention. Referring to FIG. 3, the RLP processing part 210 includes an RLP controller 212, a receive data buffer 214, a retransmission counter (REX_COUNT) 216, and a retransmission timer (REXMIT_TIMER) 218. The RLP controller 212 controls the operation of the RLP processing part 210. In particular, since the RLP controller 212 performs operations according to the first and second preferred embodiments described in detail below, detailed description of the RLP controller 212 is omitted.

The REX_COUNT 216 counts the number of retransmission request frames and provides the obtained REX_COUNT value to the RLP controller 212. The REXMIT_TIMER 218 is configured with more than one timer set when a non-received frame is detected by the RLP controller 212. The receive data buffer 214 stores frames to be transmitted to the upper layer by the RLP controller 212. As described above, if a frame of a sequence number adjacent to a sequence number of a non-received frame is received, the frame of a sequence number adjacent to a sequence number of a non-received frame is stored in the receive data buffer 214.

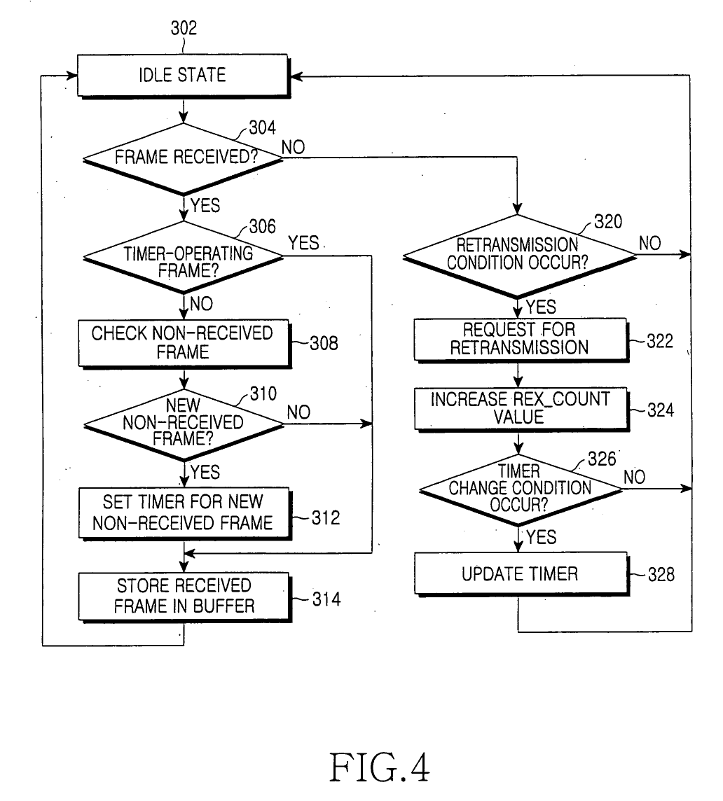

A process of receiving data in the RLP processing part 210 according to a preferred embodiment of the present invention will now be described with reference to FIG. 4.

Referring to FIG. 4, in step 302, the RLP processing part 210 maintains an idle state. Herein, the idle state is a state of waiting for an occurrence of an event that requests a specific operation. In step 304, the RLP processing part 210 determines if a frame is received. If a frame is received, in step 306, the RLP processing part 210 determines if a frame whose timer is operating is received. The frame whose timer is operating is a frame whose timer is set for the RLP processing part 210 to determine if the frame was a missed frame since the RLP processing part 210 knows that the frame is a non-received frame. If the RLP processing part 210 has received the frame whose timer is operating, the process proceeds to step 314.

If the received frame is not a frame whose timer is operating, in step 308, the RLP processing part 210 determines if there exists a non-received frame. As described above, the RLP processing part 210 can determine if there exists a new non-received frame by checking a sequence number of the received frame. If there exists a new non-received frame, in step 312, the RLP processing part 210 sets a timer (REXMIT_TIMER) for the new non-received frame, and the process proceeds to step 314. If there does not exist a new non-received frame, the process proceeds to step 314. In step 314, the RLP processing part 210 stores the received frame in a buffer.

If it is determined that a frame is not received in step 304, in step 320, the RLP processing part 210 determines if a retransmission condition occurs. For example, the RLP processing part 210 determines if a timeout of a timer occurs. As described above, the timer is set by the RLP processing part 210 for a non-received frame, if a timeout of the timer occurs, the RLP processing part 210 determines that the frame is a missed frame and requests retransmission from a transmitter. Thus, if a timeout of the timer occurs, in step 322, the RLP processing part 210 requests retransmission from the transmitter of a relevant frame. In step 324, the RLP processing part 210 increases a REX_COUNT value obtained by counting the number of retransmission request frames. In step 326, the RLP processing part 210 determines if a timer change condition occurs. In general, since frames are well received if a current communication state is excellent, the REX_COUNT value is less if the number of retransmission request frames decreases. In other words, since the number of received invalid frames, such as missed frames and erased frames, increases if the current communication state is deteriorated, the REX_COUNT value is greater if the number of retransmission request frames increases.

According to a preferred embodiment of the present invention, the RLP processing part 210 determines if a timer change condition occurs based on the REX_COUNT value. If the timer change condition occurs, in step 328, the RLP processing part 210 updates a relevant timer (REXMIT_TIMER) value to fit a current communication environment. If the current communication environment is excellent, the RLP processing part 210 reduces an unnecessary wait by decreasing the REXMIT_TIMER value and quickly requests for retransmission. If the current communication environment is deteriorated, the RLP processing part 210 increases a frame waiting time by increasing the REXMIT_TIMER value.

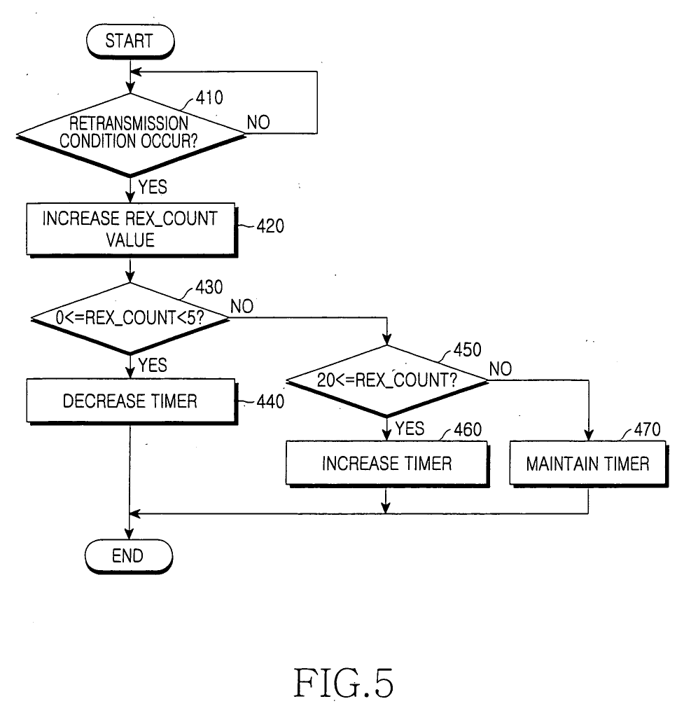

A process of updating a REXMIT_TIMER value according to a first preferred embodiment of the present invention will now be described with reference to FIG. 5. According to the first preferred embodiment of the present invention, the RLP processing part 210 updates a REX_COUNT value at every unit time when a frame is generated (a 20 ms unit for an FCH and an SCH) and updates the REX_COUNT value by selecting one of ‘increment,’ ‘decrement,’ and ‘maintaining a current value’ according to which range the REX_COUNT value is in.

When a frame is not received in a real network, retransmission always occurs on a 20 ms basis, and the REXMIT_TIMER is also used at 20 ms intervals. Since the REXMIT_TIMER should maintain a value sensitive to a retransmission situation, the process of FIG. 5 is performed at every 20 ms. The process of FIG. 5 can be performed with another period of time.

Referring to FIG. 5, in step 410, the RLP processing part 210 determines if a retransmission condition occurs. For example, the RLP processing part 210 determines if a timeout of a timer (REXMIT_TIMER) occurs. The REXMIT_TIMER is a timer set by the RLP processing part 210 for a non-received frame, and if the timeout of the REXMIT_TIMER occurs, the RLP processing part 210 determines that the non-received frame is a missed frame. It will be understood by those skilled in the art that a retransmission condition of a frame can occur due to another cause. If the timeout of the REXMIT_TIMER occurs, in step 420, the RLP processing part 210 increases a REX_COUNT value obtained by counting the number of retransmission request frames. In step 430, the RLP processing part 210 determines if the REX_COUNT value is less than 5. In detail, since the retransmission of a frame would usually not occur if a current communication state is excellent, the RLP processing part 210 determines if the REX_COUNT value is less than a first predetermined value. In the current example, a value of 5 is used as the predetermined value.

If the REX_COUNT value is less than 5, in step 440; the RLP processing part 210 decreases a REXMIT_TIMER value. That is, if the current communication state is excellent, the RLP processing part 210 reduces an unnecessary wait by decreasing the REXMIT_TIMER value and quickly requests for retransmission. It will be clear that the RLP processing part 210 may change the REXMIT_TIMER value by a predetermined range.

If the REX_COUNT value is not less than 5, in step 450, the RLP processing part 210 determines if the REX_COUNT value is equal to or greater than 20. If the current communication state is deteriorated, since retransmission of a frame more frequently occurs due to an invalid frame such as a missed frame or an erased frame, the RLP processing part 210 determines if the REX_COUNT value is equal to or greater than a second predetermined value (here, it is 20). If the REX_COUNT value is equal to or greater than 20, in step 460, the RLP processing part 210 increases the REXMIT_TIMER value. That is, if the current communication state is deteriorated, the RLP processing part 210 increases a waiting time for a relevant frame by increasing the REXMIT_TIMER value. If the REX_COUNT value is less than 20, in step 470, the RLP processing part 210 maintains the REXMIT_TIMER value without any change. The process can be summarized as follows.

| | |
|---|---|
| 0 <= REX_COUNT < 5 | REXMIT_TIMER decrement |
| 5 <= REX_COUNT < 20 | REXMIT_TIMER maintaining |
| 20 <= REX_COUNT | REXMIT_TIMER increment. |

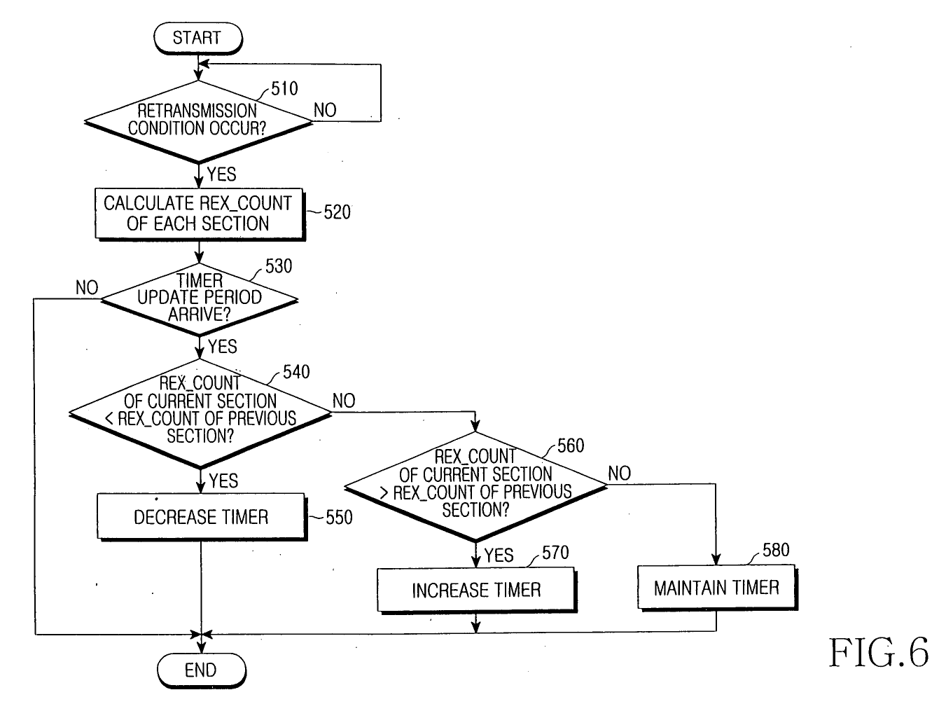

A process of updating a REXMIT_TIMER value according to a second preferred embodiment of the present invention will now be described with reference to FIG. 6. According to the second preferred embodiment of the present invention, a REX_COUNT value is checked at each time section, REX_COUNT values of time sections are compared to each other, and according to the comparison result, a REXMIT_TIMER value is updated by selecting one of ‘increment,’ ‘decrement,’ and ‘maintaining a current value.’

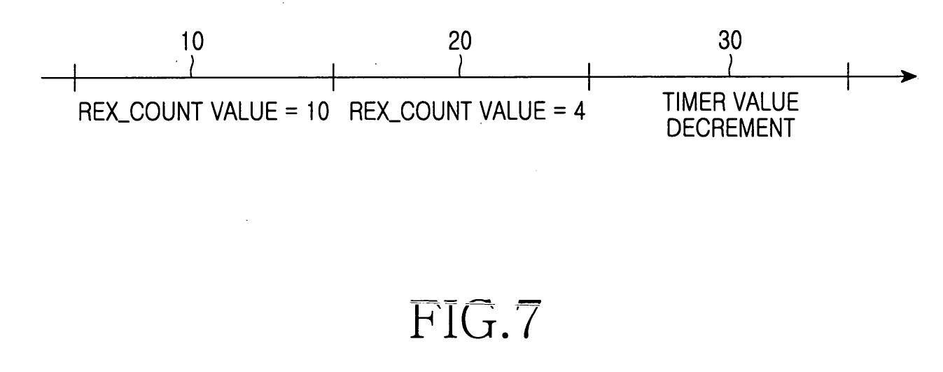

Referring to FIG. 6, in step 510, the RLP processing part 210 determines if a retransmission condition occurs. If a retransmission condition occurs, in step 520, the RLP processing part 210 calculates REX_COUNT values of time sections. FIG. 7 is a diagram illustrating the REX_COUNT values of time sections. Referring to FIG. 7, a REX_COUNT value of a section 10 is 10, and a REX_COUNT value of a section 20 is 4. That is, the RLP processing part 210 counts the number of transmission request frames of each predetermined time section. In step 530, the RLP processing part 210 determines if a timer update period arrives. The timer update period is determined to respond to a communication state without giving a load to the reception apparatus. It is preferable that the timer update period be greater than 20 ms, which is the timer update period in the first preferred embodiment and have a time range in which several frames can be received.

If the timer update period arrives, in step 540, the RLP processing part 210 determines if a REX_COUNT value of a current section is less than a REX_COUNT value of a previous section. In the example of FIG. 7, if the current section is the section indicated by 20, the RLP processing part 210 compares the REX_COUNT value of the section 20 with the REX_COUNT value of the section 10. If the REX_COUNT value of the current section is less than the REX_COUNT value of the previous section, in step 550, the RLP processing part 210 decreases a timer (REXMIT_TIMER) value. That is, the RLP processing part 210 determines that the number of retransmissions is less since a communication state is excellent, reduces the waiting time by decreasing the REXMIT_TIMER value and quickly requests for retransmission.

If the REX_COUNT value of the current section is not less than the REX_COUNT value of the previous section, in step 560, the RLP processing part 210 determines if the REX_COUNT value of the current section is greater than the REX_COUNT value of the previous section. If the REX_COUNT value of the current section is greater than the REX_COUNT value of the previous section, in step 570, the RLP processing part 210 increases the REXMIT_TIMER value. That is, the RLP processing part 210 determines that the number of retransmissions is greater since a communication state is deteriorated and increases a waiting time of a relevant frame by increasing the REXMIT_TIMER value.

If the REX_COUNT value of the current section is neither greater nor less than the REX_COUNT value of the previous section, in step 580, the RLP processing part 210 maintains the REXMIT_TIMER value without any change.

In the second preferred embodiment, while it has been described that the REXMIT_TIMER value is increased or decreased in a predetermined range since the REXMIT_TIMER value is changed for each predetermined section, it will be clear to those skilled in the art that the REXMIT_TIMER value can be increased or decreased similarly to the first preferred embodiment.

The present invention can be applied to an arbitrary communication system using transmission of a byte stream via a radio channel.

As described above, according to embodiments of the present invention, since an optimal frame retransmission process is performed by taking into account the real-time communication environment and calculating a REXMIT_TIMER value suitable for the situation without using a fixed REXMIT_TIMER value, a reception apparatus can react sensitively to a communication state.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for determining a timer value for determining the status of a frame in a reception apparatus of a mobile communication system adopting a radio link protocol (RLP), the method comprising the steps of:
counting the number of frames whose retransmission is requested; and
updating the timer value for determining the status of a frame by referring to the counting value.

2. The method of claim 1, wherein the updating step comprises the step of decreasing the timer value if the counting value is less than a first threshold.

3. The method of claim 2, wherein the updating step comprises the step of increasing the timer value if the counting value is greater than or equal to a second threshold.

4. The method of claim 3, wherein the updating step comprises the step of maintaining the timer value if the counting value is greater than the first threshold and less than the second threshold.

5. A method for determining a timer value for determining the status of a frame in a reception apparatus of a mobile communication system adopting a radio link protocol (RLP), the method comprising the steps of:
counting of each time section the number of frames whose retransmission is requested; and
updating the timer value for determining the status of a frame by referring to the counting value of each time section.

6. The method of claim 5, wherein the updating step comprises the step of comparing counting values of time sections, and updating the timer value for determining the status of a frame according to the comparison result.

7. The method of claim 6, wherein the updating step comprises the step of decreasing the timer value for determining the status of a frame if a counting value of a current time section is less than a counting value of a previous time section.

8. The method of claim 6, wherein the updating step comprises the step of increasing the timer value for determining the status of a frame if a counting value of a current time section is greater than a counting value of a previous time section.

9. The method of claim 6, wherein the updating step comprises the step of maintaining the timer value for determining the status of a frame if a counting value of a current time section is neither greater nor less than a counting value of a previous time section.

10. A reception apparatus for determining a timer value for determining the status of a frame in a mobile communication system adopting a radio link protocol (RLP), comprising:
a physical layer (PHY) processing part for decoding a received frame and transmitting the decoded frame; and
an RLP processing part for counting the number of frames whose retransmission is requested and updating the timer value for determining the status of a frame by referring to the counting value.

11. A reception apparatus for determining a timer value for determining the status of a frame in a mobile communication system adopting a radio link protocol (RLP), comprising:
a physical layer (PHY) processing part for decoding a received frame and transmitting the decoded frame; and
an RLP processing part for counting of each time section the number of frames whose retransmission is requested and updating the timer value for determining the status of a frame by referring to the counting value of each time section.
